(19) United States
(12) Patent Application Publication
(10) Pub. No.: US 2025/0211668 A1
(43) Pub. Date: Jun. 26, 2025

(54) CALL COUNT MANAGEMENT IN 5G STAND-ALONE TELECOMMUNICATIONS NETWORKS

(71) Applicant: DISH Network Technologies India Private Limited, Bangalore (IN)

(72) Inventor: Alivelu Venkata Neelima Mutheevi, Hyderabad (IN)

(21) Appl. No.: 18/394,604

(22) Filed: Dec. 22, 2023

(51) Int. Cl. H04M 1/56

(52) U.S. Cl. CPC H04M 1/56; H04M 2250/60

(57) ABSTRACT

Systems and methods of managing call counts in a telecommunications network perform or comprise: initializing a call count management script; receiving an input, the input including at least one of an input type, an input target, and a test identifier; retrieving a list of target network entities from a database, based on the input; generating an output report; and for each target network entity in the list of target network entities, and in response to a determination that a call count of the target network entity is greater than a predetermined threshold, adding the target network entity to the output report.

### BACKGROUND

This disclosure relates to wireless data networks, such as 5G wireless networks. Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously-available technologies.

The discussion above is merely provided for general background information and is not intended to be used as an aid in determining the scope of the claimed subject matter.

### SUMMARY

Various aspects of the present disclosure relate to systems and methods in a virtualized telecommunications network to monitor, analyze, and manage call counts in an automated manner.

According to one aspect of the present disclosure, a method of managing call counts in a telecommunications network is provided. The method comprises initializing a call count management script; receiving an input, the input including at least one of an input type, an input target, and a test identifier; retrieving a list of target network entities from a database, based on the input; generating an output report; and for each target network entity in the list of target network entities, and in response to a determination that a call count of the target network entity is greater than a predetermined threshold, adding the target network entity to the output report.

According to another aspect of the present disclosure, a telecommunications network is provided. The telecommunications network comprises a wireless access point configured to communicate with a user equipment; and a virtual radio access network (RAN) server operatively connected to the wireless access point, the virtual RAN server configured to: initialize a call count management script, receive an input, the input including at least one of an input type, an input target, and a test identifier, retrieve a list of target network entities from a database, based on the input, generate an output report, and for each target network entity in the list of target network entities, and in response to a determination that a call count of the target network entity is greater than a predetermined threshold, add the target network entity to the output report.

According to another aspect of the present disclosure, a non-transitory computer-readable medium is provided. The non-transitory computer-readable medium stores instructions that, when executed by at least one processor of a computer in a telecommunications network, cause the computer to perform operations comprising: initializing a call count management script; receiving an input, the input including at least one of an input type, an input target, and a test identifier; retrieving a list of target network entities from a database, based on the input; generating an output report; and for each target network entity in the list of target network entities, and in response to a determination that a call count of the target network entity is greater than a predetermined threshold, adding the target network entity to the output report.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 illustrates an example of a 5G radio access network in accordance with various aspects of the present disclosure.

FIG. 4 illustrates an example of a call count management method in accordance with various aspects of the present disclosure.

FIG. 5 illustrates an example of a call count management system in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

In an O-RAN model, each CU can cater to a specific number of simultaneous Voice Over New Radio (VONR) calls at maximum. If the number of active calls exceeds this maximum number, then either the new calls are not connecting or existing calls are dropped. Both of these scenarios result in a loss of calls for the end user (e.g., a subscriber or client). Additionally, in some cases if the call counter is greater than a threshold percentage of this maximum number, packet loss may occur. Therefore, there exists a need for systems and methods of monitoring the number of VONR calls per cell under the CU and, if a predetermined threshold of the call limit is met or exceeded, enabling investigations into the cell and possibly enabling an operator to take further action.

The present disclosure describes automated systems and methods of monitoring the VONR call counts and reporting which cells are meeting the threshold or exceeding the threshold. In comparative systems and methods, in order to perform any monitoring or management operations, network operators or engineers are required to manually access network components to run checks. The systems and methods set forth herein provide improved flexibility in network management, increased efficiency in the utilization of limited network resources, reduced processing overhead, and/or reduced utilization of personnel time by 90%-99% compared to the comparative systems and methods. Additionally, the comparative systems and methods are unable to measure call activity from multiple cells, whereas systems and methods according to the present disclosure may be scaled up to manage a large number of cells (e.g., thousands or more) concurrently.

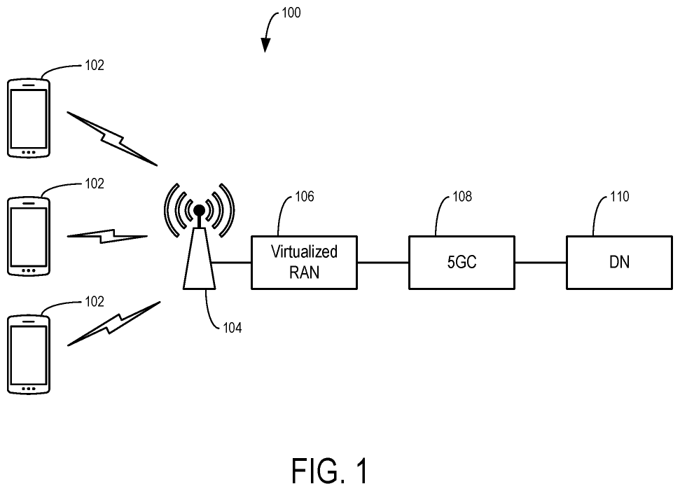

FIG. 1 illustrates an example of a telecommunications network 100 in accordance with various aspects of the present disclosure. In the telecommunications network 100 of FIG. 1, a plurality of user equipment (UEs) 102 are connected to a wireless access point 104, which in turn is connected to a set of virtualized radio access network (RAN) components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (APs), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

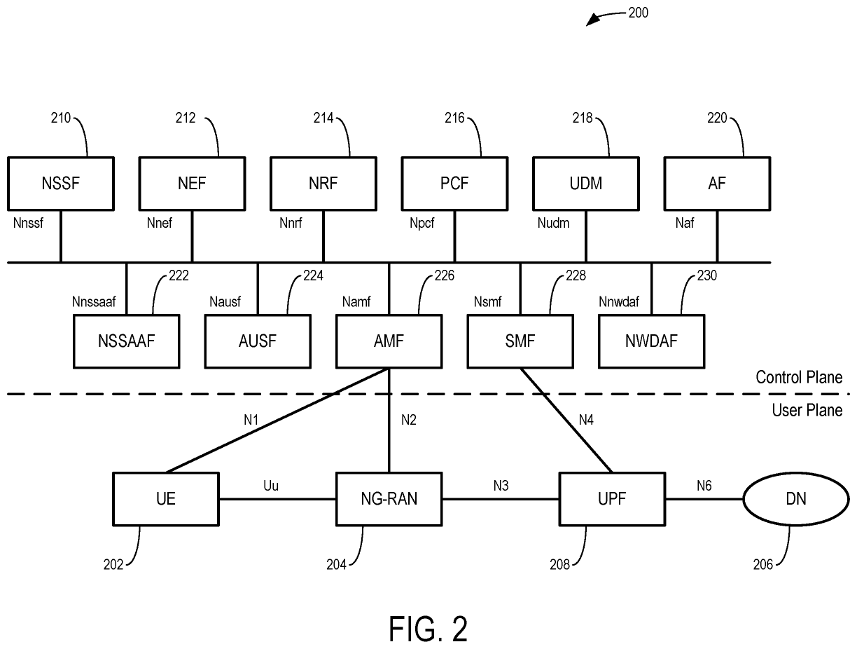

The 5GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 is divided between a control plane (CP) and a user plane (UP). The CP comprises a plurality of CP network functions (NFs). The UP comprises a UE 202 (e.g., one of the UEs 102 of FIG. 1) connected to an NG-RAN 204, and UP NFs. Using the SBA 200, the UE 202 accesses a data network 206 (e.g., the data network 110 of FIG. 1). For ease of illustration, FIG. 1 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet). The UPF 208 is similar to the service and packet gateway functions in a 4G network, but it is cloud-native and can be deployed anywhere to meet service requirements. It can also manage, prioritize, and duplicate data packets as they traverse the network, thus offering redundancy and quality-of-service (QOS) assurance.

The CP NFs include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The PCF 216 is a CP function that provides policies for mobility and session management. It is similar to the Policy and Charging Rules Function (PCRF) in a 4G network, but it is cloud-native and offers additional capabilities in the 5G network, including event-based policy triggers, resource reservation requests, and access network discovery and selection. The PCF directly influences QoS and subscriber spending limits, and as a result plays a role in the enhanced policy management and control capabilities of the 5G network.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the tasks of the serving and packet gateways (S-GW & P-GW) in a 4G network, but also allows for control plane and user plane separation in 5G.

The NWDAF 230 is a CP function that collects data from pertinent network infrastructure relevant to a customer's services, including user equipment (device), network functions, network operations and administration, cloud, and edge that can be used for data analytics and insights. It is a unique standalone 5G network function that exposes full visibility to network performance and operations as they relate to a customer's key performance indicators (KPIs).

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Npcf for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an NI interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the telecommunications network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the SBA 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

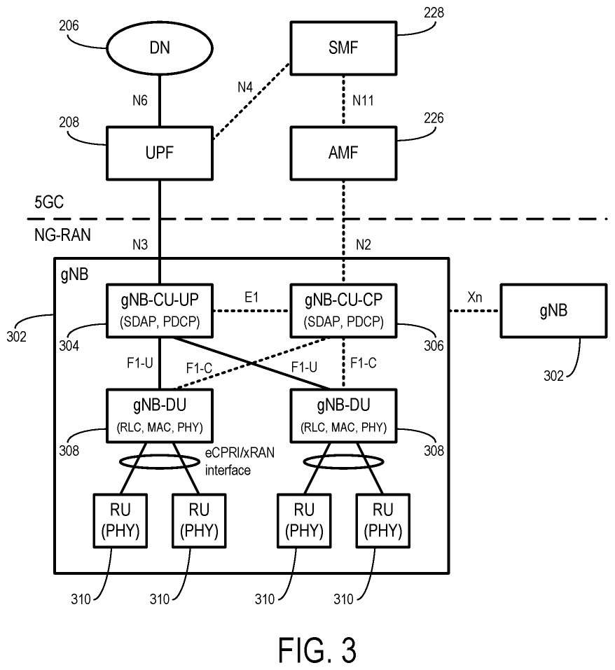

FIG. 3 illustrates an example of various components of the SBA 200 in more detail. For purposes of clarity and ease of explanation, the UE 202 and components of the 5GC other than the data network 206, the UPDF 208, the AMF 226, and the SMF 228 are omitted. The UPF 208 and the SMF 228 are connected to one another via an N4 interface, and the AMF 226 and the SMF 228 are connected to one another via an N11 interface. As shown in FIG. 3, the NG-RAN 204 includes a plurality of gNBs 302. Although FIG. 3 illustrates two gNBs 302, in practical implementations any number of gNBs 302 may be present.

The gNB 302 includes a CU divided into a gNB Control Unit User Plane (gNB-CU-UP) 304 and a gNB Control Unit Control Plane (gNB-CU-CP) 306. The gNB-CU-UP 304 is connected to the UPF 208 via an N3 interface, and the gNB-CU-CP 306 is connected to the AMF 226 via an N2 interface (i.e., backhaul links). The gNB 302 further includes a gNB-DU 308, of which two are illustrated although any number of gNB-DUs 308 may be present. The gNB-DU 308 is connected to the gNB-CU-UP 304 via an F1-U interface and is connected to the gNB-CU-CP 306 via an F1-C interface (i.e., midhaul links). In one example, the CU and gNB-DU 308 are developed using the Kubernetes architecture. The gNB 302 further includes an RU 310, of which two per gNB-DU 308 are illustrated although any number of RUs 310 may be present, including different numbers of RUs 310 per gNB-DU 308. The RU 310 is connected to the gNB-DU 308 via a evolved Common Public Radio Interface (eCPRI) connection and/or an xRAN interface (i.e., fronthaul links). The interfaces shown in FIG. 3 may be implemented as IP interfaces (i.e., having end-points denoted by IP addresses).

The 5G radio protocol stack is divided among the CU, the gNB-DU 308, and the RU 310. As illustrated, the gNB-CU-UP 304 and the gNB-CU-CP 306 include the Service Data Adaptation Protocol (SDAP) and the Packet Data Convergence Protocol (PDCP); the gNB-DU 308 includes the Radio Link Control (RLC) protocol, the Medium Access Control (MAC) protocol, and the Physical Layer (PHY) protocol; and the RU 310 includes the PHY protocol. Data passes through the protocol stack along a path that depends on the data type. Control data (e.g., signaling messages, etc.) pass through the control plane including the gNB-CU-CP 306, whereas user data passes through the user plane including the gNB-CU-UP 304.

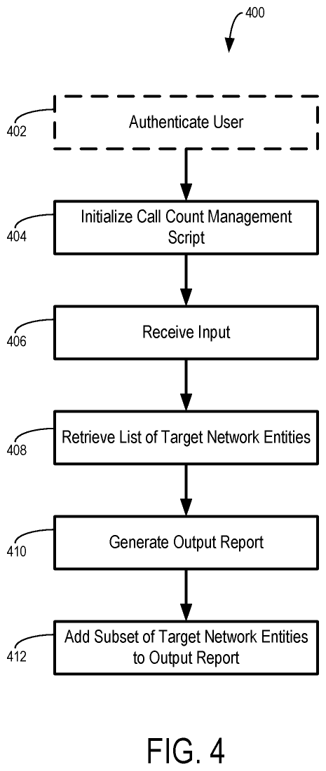

Various pods of the NG-RAN 204 (e.g., pods of the gNB-CU-UP 304 and/or of the gNB-CU-CP 306) may be interrogated to implement various network management systems and methods. FIG. 4 illustrates one example of a call count management method 400 in accordance with the present disclosure. For purposes of explanation, FIG. 4 will be described as being implemented in a 5G O-RAN network; however, in practice the method 400 may be implemented with any virtualized RAN architecture. Moreover, for purposes of explanation, FIG. 4 will be described as being implemented in a network operating using AWS with pods using Kubernetes; however, these are merely examples and not limiting. The systems and methods of the present disclosure may be implemented with other web services provider and with other container organization architectures.

The method 400 may be performed under the direction of a user (e.g., a network engineer or other personnel) or may be performed in an automated manner (e.g., automatically at a predetermined interval). In user-directed implementations, the method 400 may begin with an operation 402 of authenticating the user. For example, the user may log on to the vendor and/or a region-specific AWS Elastic Compute Cloud (EC2) instance using the appropriate authentication keys (e.g., username/passwords, one-time codes (OTCs), etc.). Thus, operation 402 may include determining whether a user has entered an appropriate authentication key and, if so, granting the user access. However, even in user-directed implementations, operation 402 may be omitted in certain situations (e.g., if the user has already properly logged on). In automated implementations, operation 402 may also be omitted.

At operation 404, a call count management script is initialized. The initialization operation may include downloading the script from a database. In the AWS implementation example, the script may be downloaded from a specific Simple Storage Service (S3) bucket. By downloading the script at or near run-time, it can be ensured that the most recent version of the script is used for execution.

At operation 406, an input is received. In user-directed implementations, the user may manually execute the script by inputting script-specific commands. In automated implementations, the input may be loaded from a local or external memory. In either implementation, the input may include at least one of an input type (e.g., region, market, AOI, gNB, etc.), an input target (e.g., a specific AWS region, one or more markets, one or more AOIs, one or more gNB, etc.), and a test identifier. The input may specify any input type and input target combination as desired. The test identifier may be any alphanumeric string which will be prepended to or otherwise concatenated with the outputs of the script (described in more detail below), thereby to allow the outputs of different script executions to be easily differentiated.

At operation 408, a list of target network entities is retrieved. The list of target network entities may be based on the input; for example, the list of target network entities may identify all sites (e.g., all DUs, all gNBs, etc.) which correspond to the input type and input target received in operation 406. The list of target network entities may be retrieved from a database, which may be the same as or different than the database queried in operation 404. By retrieving the list from a database at run time, there may be no need for the input to include every detail needed to execute the script. This is especially beneficial where the input type is market or AOI, in which case the number of gNBs to be included in the list may be large.

At operation 410, an output report is generated. The output report may be generated as a new, blank report. Alternatively, the output report may be an existing report. The script is configured to check every CU-UP (e.g., gNB-CU-UP 304 for every gNB 302 that is a target entity) to determine the call counts (e.g., VONR call counts). This may be accomplished by accessing the CU-CP pod responsible for VONR calls of each target gNB and retrieving a predetermined number of call count logs. For example, the script may access the five most recent call count logs. The script may then compare each log to a predetermined threshold. The predetermined threshold may be, for example, a predetermined proportion of the maximum number of active calls which the target network entity is capable of supporting. In one example, the predetermined threshold is 75% of the maximum number of active calls.

If the call count is greater than or equal to the predetermined threshold, the target network entity is added to the output report at operation 412. The target network entity may be added to the output report if any subset of the predetermined number of call count logs (e.g., any one, any two, any three, etc.) exceed the threshold. As noted above, to ensure that output reports from different script executions may be distinguished, a network identifier of the target network entity may be concatenated with the test identifier from operation 406 to generate a combined identifier, and the combined identifier may be added to the output report. Operation 412 may be repeated for each target network entity until the list is exhausted. After operation 412, the output report may include the active pod name, log file name, cell numbers of those cells whose call count exceeds the threshold, number of active VONR calls, and NR cell ID for those cells whose call count exceeds the threshold. In the event that none of the call count logs for any target network identifier exceeds the threshold, a null indicator (e.g., the word “None”) may instead by be added to the output report.

Once all network entities have been analyzed, the output report and any logs may be automatically uploaded, for example to a database. The database may be the same as or different than the databases from operation 404 and/or operation 408. Thus, the user or another user can download the results and logs at any time (e.g., into their local computer) for further usage and/or analyses. With the output report uploaded, it may then be deleted from memory (e.g., from the EC2 instance) to reduce memory utilization.

If the output log indicates that certain network entities exceed the call count threshold, remedial action may be automatically or manually taken. The remedial action may be any action to reduce the call count relative to the threshold of the sites identified in the output report. For example, the remedial action may include allocating additional VONR resources to the identified site(s), transferring users from one site to another (if the user is in the coverage area of multiple sites), modifying network settings, and the like.

The operations of FIG. 4 are not necessarily performed one after another in a strict sequence according to the order illustrated in FIG. 4. For example, operation 404 may only be performed after (and in response to) operation 406; operation 410 may be performed at any time prior to operation 412; operation 402 may be performed multiple times (e.g., after a certain amount of time has elapsed, thereby to ensure that the original user is still present); and so on. Moreover, in some implementations, operations 404-412 may be performed repeatedly at a predetermined interval. The predetermined interval may be set by a network operator.

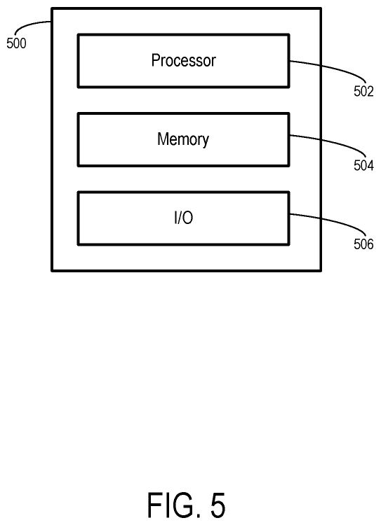

The method 400 may be implemented by a device operating in a telecommunications network. For example, in a telecommunications network including a wireless access point (e.g., wireless access point 104 of FIG. 1) configured to communicate with a UE (e.g., UE 102 of FIG. 1), the method 400 may be implemented on a virtual RAN server (e.g., virtualized RAN components 106 of FIG. 1) that is operatively connected to the wireless access point. FIG. 5 illustrates one example of a virtual RAN server 500.

As illustrated, the virtual RAN server 500 comprises a processor 502, a memory 504, and an input/output (I/O) interface 506. The virtual RAN server 500 may be configured with various modules (e.g., various software modules) to implement network management functions, such as VONR call count management functions. In one example, the modules may be present in the memory 504 in the form of instructions that, when executed by the processor 502, cause the virtual RAN server 500 to perform any one or more of the operations described herein. In another example, the processor 502 may be configured to load and/or execute instructions from another non-transitory computer-readable medium (e.g., cloud storage or from the memory of another device).

The virtual RAN server 500 may comprise an authentication module to authenticate a user. For example, the authentication module may determine whether a user has entered appropriate authentication information and, if so, grant the user access to perform further operations.

The virtual RAN server 500 may comprise a script initialization module to initialize a call count management script. The initialization operation may include downloading the script from a database. In the AWS implementation example, the script may be downloaded from a specific S3 bucket. By downloading the script at or near run-time, it can be ensured that the most recent version of the script is used for execution.

The virtual RAN server 500 may comprise an input parsing module to parse inputs received from a user or from another device. In user-directed implementations, the user may manually execute the script by inputting script-specific commands. In automated implementations, the input may be loaded from a local or external memory. In either implementation, the input may include at least one of an input type (e.g., region, market, AOI, gNB, etc.), an input target (e.g., a specific AWS region, one or more markets, one or more AOIs, one or more gNB, etc.), and a test identifier. The input may specify any input type and input target combination as desired. The test identifier may be any alphanumeric string which will be prepended to or otherwise concatenated with the outputs of the script (described in more detail below), thereby to allow the outputs of different script executions to be easily differentiated.

The virtual RAN server 500 may comprise a network retrieval module to retrieve lists of target network entities. The list of target network entities may be based on the input; for example, the list of target network entities may identify all sites (e.g., all DUs, all gNBs, etc.) which correspond to the input type and input target received by the input parsing module. The list of target network entities may be retrieved from a database. By retrieving the list from a database at run time, there may be no need for the input to include every detail needed to execute the script. This is especially beneficial where the input type is market or AOI, in which case the number of gNBs to be included in the list may be large.

The virtual RAN server 500 may comprise an output report module to generate an output report. The output report may be generated as a new, blank report. Alternatively, the output report may be an existing report. The script is configured to check every CU-UP (e.g., gNB-CU-UP 304 for every gNB 302 that is a target entity) to determine the call counts (e.g., VONR call counts). This may be accomplished by accessing the CU-CP pod responsible for VONR calls of each target gNB and retrieving a predetermined number of call count logs. For example, the script may access the five most recent call count logs. The script may then compare each log to a predetermined threshold. The predetermined threshold may be, for example, a predetermined proportion of the maximum number of active calls which the target network entity is capable of supporting. In one example, the predetermined threshold is 75% of the maximum number of active calls.

The virtual RAN server 500 may comprise a logic module to perform arithmetic operations such as data comparison. The logic module may be configured to compare the call count in the call count logs to the predetermined threshold. If the call count is greater than or equal to the predetermined threshold, the target network entity is added to the output report. The target network entity may be added to the output report if any subset of the predetermined number of call count logs (e.g., any one, any two, any three, etc.) exceed the threshold. As noted above, to ensure that output reports from different script executions may be distinguished, a network identifier of the target network entity may be concatenated with the test identifier from the input parsing module to generate a combined identifier, and the combined identifier may be added to the output report. The logic operations may be repeated for each target network entity until the list is exhausted. In the event that none of the call count logs for any target network identifier exceeds the threshold, a null indicator (e.g., the word “None”) may instead by be added to the output report.

Once all network entities have been analyzed, the virtual RAN server 500 may output the output report and any logs, for example to a database and/or to a local storage. Thus, the user or another user can download the results and logs at any time (e.g., into their local computer) for further usage and/or analyses. With the output report uploaded, it may then be deleted from memory (e.g., from the EC2 instance) to reduce memory utilization.

The I/O 506 may include interface components to permit the communication of data to and from external devices or sources. For example, the I/O 506 may include communication ports and/or interfaces to permit communication with other computer devices. The communication ports and/or interfaces may permit input and output via wired protocols (e.g., Ethernet, Universal Serial Bus (USB), FireWire, etc.) and/or wireless protocols (e.g., Wi-Fi, Bluetooth, Near Field Communication (NFC), 5G, 4G, etc.). The I/O 506 may additionally or alternatively include communication ports and/or interfaces to permit communication with a user. For example, the I/O 506 may include interfaces for a mouse, a keyboard, a display, a graphical user interface (GUI), buttons, switches, etc. Thus, the I/O 506 may permit a user to initiate the scripts described herein on an ad-hoc basis and/or may be configured to receive instructions for the automated execution of the scripts described herein (e.g., at predetermined intervals).

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of managing call counts in a telecommunications network, the method comprising:
initializing a call count management script;
receiving an input, the input including at least one of an input type, an input target, and a test identifier;
retrieving a list of target network entities from a database, based on the input;
generating an output report; and
for each target network entity in the list of target network entities, and in response to a determination that a call count of the target network entity is greater than a predetermined threshold, adding the target network entity to the output report.

2. The method of claim 1, wherein the list of target network entities is a list of target distributed units operating under the control of a target control unit.

3. The method of claim 2, further comprising:
accessing a control plane pod of the target control unit and retrieving a predetermined number of call count logs.

4. The method of claim 1, further comprising:
uploading the output report to the database; and
deleting the output report from a local memory.

5. The method of claim 1, further comprising:
prior to receiving the input, authenticating a user.

6. The method of claim 1, wherein adding the target network entity to the output report includes determining a network identifier of the target network entity, concatenating the network identifier with the test identifier to generate a combined identifier, and adding the combined identifier to the output report.

7. The method of claim 1, wherein the predetermined threshold is a predetermined proportion of a maximum number of active voice over new radio (VONR) calls that the target network entity is capable of supporting.

8. The method of claim 1, further comprising:
repeating the operations of initializing, retrieving, generating, and adding at a predetermined interval.

9. A telecommunications network comprising:
a wireless access point configured to communicate with a user equipment; and
a virtual radio access network (RAN) server operatively connected to the wireless access point, the virtual RAN server configured to:
initialize a call count management script,
receive an input, the input including at least one of an input type, an input target, and a test identifier,
retrieve a list of target network entities from a database, based on the input,
generate an output report, and
for each target network entity in the list of target network entities, and in response to a determination that a call count of the target network entity is greater than a predetermined threshold, add the target network entity to the output report.

10. The telecommunications network of claim 9, wherein the virtual RAN server is configured to implement an Open RAN architecture.

11. The telecommunications network of claim 9, wherein the virtual RAN server includes at least one control unit virtual machine and a plurality of distributed unit virtual machines.

12. The telecommunications network of claim 11, wherein the list of target network entities is a list of target distributed units operating under the control of a target control unit virtual machine.

13. A non-transitory computer-readable medium storing instructions that, when executed by at least one processor of a computer in a telecommunications network, cause the computer to perform operations comprising:
initializing a call count management script;
receiving an input, the input including at least one of an input type, an input target, and a test identifier;
retrieving a list of target network entities from a database, based on the input;
generating an output report; and
for each target network entity in the list of target network entities, and in response to a determination that a call count of the target network entity is greater than a predetermined threshold, adding the target network entity to the output report.

14. The non-transitory computer-readable medium of claim 13, wherein the list of target network entities is a list of target distributed units operating under the control of a target control unit.

15. The non-transitory computer-readable medium of claim 14, the operations further comprising:
accessing a control plane pod of the target control unit and retrieving a predetermined number of call count logs.

16. The non-transitory computer-readable medium of claim 13, the operations further comprising:
uploading the output report to the database; and
deleting the output report from a local memory.

17. The non-transitory computer-readable medium of claim 13, the operations further comprising:
prior to receiving the input, authenticating a user.

18. The non-transitory computer-readable medium of claim 13, wherein adding the target network entity to the output report includes determining a network identifier of the target network entity, concatenating the network identifier with the test identifier to generate a combined identifier, and adding the combined identifier to the output report.

19. The non-transitory computer-readable medium of claim 13, wherein the predetermined threshold is a predetermined proportion of a maximum number of active voice over new radio (VONR) calls that the target network entity is capable of supporting.

20. The non-transitory computer-readable medium of claim 13, the operations further comprising:
repeating the operations of initializing, retrieving, generating, and adding at a predetermined interval.
